(19) United States
(12) Patent Application Publication
(10) Pub. No.: US 2024/0044019 A1
(43) Pub. Date: Feb. 8, 2024

(54) A METHOD OF PRODUCING SILICON

(71) Applicant: HELIOS PROJECT LTD, Hod Hasharon (IL)

(72) Inventors: Jonathan HAUSNER, Kochav Yair (IL); Jonathan GEIFMAN, Hod Hasharon (IL); Linoam ELIAD, Modi’in (IL); Yossi GOFER, Kochav Yair (IL); Oran LORI, Petach Tikua (IL)

(73) Assignee: HELIOS PROJECT LTD, Hod Hasharon (IL)

(21) Appl. No.: 18/255,895

(22) PCT Filed: Dec. 6, 2021
(86) PCT No.: PCT/IL2021/051447

§ 371 Date: Jun. 5, 2023

Related U.S. Application Data
(60) Provisional application No. 63/121,935, filed on Dec. 6, 2020.

(51) Int. Cl. C25B 1/33; C25B 15/021; C25B 9/09

(52) U.S. Cl. CPC C25B 1/33; C25B 15/021; C25B 9/09

(57) ABSTRACT

It is the object of the present invention to present a method of producing silicon, characterized by mixing silicon dioxide and at least one metal oxide at an elevated temperate wherein said oxide and silicon form a eutectic mixture or eutectic system.

### FIELD OF INVENTION

This invention is in the field of high-grade silicon production

### BACKGROUND OF INVENTION

There are a variety of methods used in industry to produce commercial grade silicon, according to the source material and final product. In some cases, the different methods use overlapping or smiler technologies.

U.S. Pat. No. 4,292,145A teaches dissolving silicon dioxide in a molten electrolytic bath, preferably comprising barium oxide and barium fluoride. A direct current is passed between an anode and a cathode in the bath to reduce the dissolved silicon dioxide to non-alloyed silicon in molten form, which is removed from the bath.

US patent U.S. Pat. No. 4,547,258 disclosed liquid silicon deposited on a high surface area column of silicon nitride particles, by hydrogen decomposition of trichlorosilane, in an environment heated to a temperature in excess of the melting point of silicon. After deposition, the liquid silicon flows by gravity to a collection point.

US patent U.S. Pat. No. 7,901,561B2 disclosed a method for electrolytic production and refining of metals having a melting point above about 1000° C., particularly silicon, where there is provided a first electrolytic cell having an upper molten electrolyte layer of a first electrolyte, a lower molten alloy layer of an alloy of the metal to be refined and at least one metal more noble than the metal to be refined. The lower alloy layer is the cathode in the first cell and an anode is positioned in the upper molten electrolyte layer. A second electrolytic cell is also provided with an upper molten metal layer of the same metal as the metal to be refined, said layer constituting a cathode, a lower molten alloy layer, said lower layer constituting an anode, said alloy having a higher density than the metal to be refined, and an intermediate molten electrolyte layer having a density between the density of the upper and lower molten layers. Both electrolytes are oxide-based electrolytes containing oxide of the metal to be refined, and the electrolyte is in molten state and has a melting point below the operating temperature of the process. Raw material comprising an oxide of the metal to be refined is added to the first cell and direct electric current is passed through the anode to the cathode such that the metal to be refined is moved from the anode and deposited in molten state at the cathode. The two cells can be operated in two separate steps. One to produce an alloy and the other to refine metal from the alloy.

Silicon is mostly found in nature as silicon-dioxide (SiO₂). The molten silicon is drained from the furnace via the tap hole where it is taken to the casting area and solidified. The final product is Metallurgical Grade Silicon (MG-Si). MG-Si is often used a raw material for the production of more pure forms, such as solar-grade (SOG) and electronic-grade silicon (EGS).

Solar Grade Silicon (SGS) is a higher purity grade of silicon. There are two main method of producing SGS from MG-Si, each producing different Solar-Grade Silicon composition: Chemical Purification (such as the siemens process and the fluidized bed process) is based on converting the Silicon species and depositing the crystalline Si in a reactor. Both commonly used methods expensive and slow, in addition to being highly energy dependent and using toxic and corrosive compounds

Metallurgical purification (Solar Grade Silicon/Upgraded MG-Si) entails obtaining solar-grade silicon directly from metallurgical-grade silicon via a series of metallurgical refining steps.

There is a long-felt need to an energy efficient and environmentally friendly method of producing high grade Si.

### SUMMARY OF THE INVENTION

It is thus one object of the present invention to disclose a method useful for the production of Silicon, comprising steps of
a. Mixing silicon dioxide and at least one metal oxide;
b. Heating/melting the silicon dioxide and metal oxide mixture;
c. creating an electronic potential;
d. cooling the Si;

It is another object of the present invention to present the method as describe above, wherein the oxide is characterized by at least one of the following:
a. A Lewis base (donor);
b. Stabile (Thermodynamic) at the reaction temperate (>2000° c.);
c. does not react with SiO₂ or Si.

It is another object of the present invention to present the method as describe above, wherein the oxide is selected from a group consisting of TiO, MgO, Li₂O, AlO and CaO.

It is another object of the present invention to present the method as describe above, wherein the metal oxide and silicon oxide mixture is characterized as forming a eutectic system.

It is another object of the present invention to present the method as describe above, additionally comprising a step of providing a crystalline seed.

It is another object of the present invention to present the method as describe above, wherein the seed is characterized as poly- or mono-crystalline.

It is another object of the present invention to present the method as describe above, wherein the heating is characterized as a melting temperate of the mixture.

It is another object of the present invention to present the method as describe above, wherein the product is characterized as poly- or mono-crystalline.

It is another object of the present invention to present the method as describe above, wherein the cooling is characterized as only crystalizing the silicon.

It is the object of the present invention to present a method of producing silicon, characterized by mixing silicon dioxide and at least one metal oxide at an elevated temperate wherein the oxide and silicon dioxide form a eutectic mixture.

It is another object of the present invention to present the method as describe above, wherein the oxide is characterized by at least one of the following:
a. A Lewis base (donor);
b. Stabile (Thermodynamic) at the reaction temperate (>2000° c.);
c. does not react with SiO₂ or Si.

It is another object of the present invention to present the method as describe above, wherein the oxide is selected from a group consisting of TiO₂, MgO, Li₂O, Al₂O₃ and CaO.

It is another object of the present invention to present the method as describe above, further characterized as cooling to a temperature, wherein only the silicon crystalizes.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention wherein:

FIG. 1—a schematic depiction of the crucible of the present invention

FIG. 2—a schematic representation of the cooling section, with integrated poly crystalline silicon to mono-crystalline silicon process.

FIG. 3—a spectrogram of Experiment 1.

FIG. 4a-b—the reactor of Experiment 1.

FIG. 5—Chronopotentiometry of Experiment 1.

FIG. 6—XRD analysis of the silicon product of Experiment 1.

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

In this application the term “eutectic system” is defined as a mixture of substances that melts at a temperature that is lower than the melting point of either of the ingredients.

In this application the term “eutectic mixture” is a mixture of compounds at a ratio (or proportions) so that the melting point is as low as possible.

In this application the term “eutectic reaction” refers to the simultaneous crystallization of the constituents of a eutectic mixture.

In this application the term “eutectic temperature” refers to the temperature that the eutectic reaction happens.

In the application, the term ‘crucible’ refers to a chamber where the melting of oxides occurs, and the formation of Si occurs.

Unless otherwise stated, all concentrations expressed as w/w %

Unless otherwise stated, with reference to numerical quantities, the term “about” refers to a tolerance of ±25% of the stated nominal value.

Unless otherwise stated, all numerical ranges are inclusive of the stated limits of the range.

### DETAILED DESCRIPTION OF THE INVENTION

Polycrystalline silicon (also known as multi-crystalline silicon, polysilicon and poly-Si) PCSi is a high purity form of silicon that is mainly used as a raw material for the (solar) photovoltaic and electronics industry. PCSi consists of small crystals (also known as crystallites), giving the material its typical metal flake effect. While polysilicon and multisilicon are often used as synonyms, multicrystalline usually refers to crystals larger than one millimeter

PCSi is widely used as metal-oxide-silicon transistor (MOS transistor, or MOS) gate electrodes and for interconnection in MOS circuits. PCSi is also used as resistor, as well as in ensuring ohmic contacts for shallow junctions.

Poly-Si is known to be compatible with high temperature processing and interfaces very well with thermal SiO₂.

In industry, PCSi is often produced from metallurgical grade silicon (MGS) by a chemical purification processes, such as the Siemens process (distillation of volatile silicon compounds and their decomposition into silicon at high temperatures) or a process of refinement (using a fluidized bed reactor). These processes are energy dependent and use toxic materials.

Electronics grade polysilicon (EG-Si) is often characterized as containing impurity levels of less than one part per billion (ppb), while polycrystalline solar grade silicon (SoG-Si) is less pure that that of Electronics grade

Silicon is often divided into three grades according to purity, correlated to the commercial use:
I. Metallurgical Grade Silicon (MG-Si): This comprises silicon of up to 98% silicon purity. This is the most used Silicon grade by volume, and also the cheapest.
II. Upgraded MGS (UMGS)/Chemical Grade Silicon (CGS)/Solar-Grade polysilicon (SOG): This grade includes (6N: 99%-99.9999%) pure silicon, with aluminum and iron as the major sources of impurity.
III. Electronic Grade Silicon/Semi-conductor Silicon (EGS/SGS): This grade includes highly pure silicon (9N: >99.9999999%). Unlike other silicon grades, this specific grade has to be 9N pure for commercial use. Many EGS manufacturers achieve 11N of quality

The typical composition of each Silicon grade:

| Element: | MG-Si | SGS | EGS |
|---|---|---|---|
| Si (%) | >99 | >99.9999 | >99.999999999 |
| Fe | 2,000-3,000 | <0.3 | <0.01 |
| Al | 1,500-4,000 | <0.1 | <0.0008 |
| Ca | 500-600 | <0.1 | <0.003 |
| B | 40-80 | <0.3 | <0.0002 |
| P | 20-50 | <0.1 | <0.0008 |
| C | 600 | <3 | <0.5 |
| O | 3000 | <10 | |
| Ti | 160-200 | <0.01 | <0.003 |
| Cr | 50-200 | <0.1 | |

Monocrystalline silicon MCSi (also known as single-crystal silicon, mono c-Si or mono-Si) is the base material for silicon-based discrete components and integrated circuits used in electronic equipment. MCSi is also used as a photovoltaic, light-absorbing material, used for the manufacture of solar cells.

MCSi consists of silicon in which the crystal lattice of the entire solid is continuous, unbroken to its edges, and free of any grain boundaries. MCSi can be prepared as an intrinsic semiconductor that consists only of exceedingly pure silicon, or it can be doped by the addition of other elements such as boron or phosphorus to make p-type or n-type silicon. Due to its semiconducting properties, availability and affordable costs, MCSi has been essential for the development of present-day electronics and information technology.

The present invention further discloses an electrochemical reactor, capable of producing a high purity, low cost, low carbon emissions polycrystalline-silicon product. In some embodiments, the reactor can further convert the polycrystalline silicon to a single-crystal silicon appropriate for the use in the semiconductor industry (e.g. purity level of 9-11 zeroes in the single-crystal-silicon final product).

### Cell Structure and Important Definitions

Reference is now made to an embodiment of the present invention disclosing the system mentioned above

Reactor system comprises various components, where the electrochemical process. The cell is structured into 2 main sections:

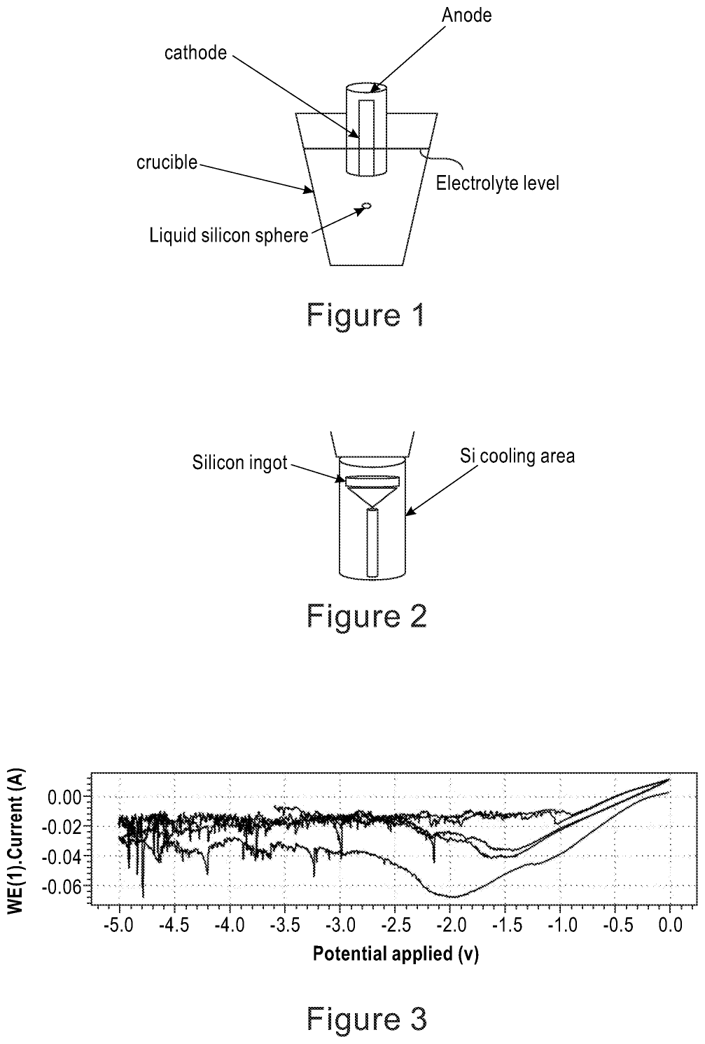

1^{st} section—crucible, where the reaction/melting/heating is conducted (FIG. 1). In some embodiments, the crucible is constructed of a plurality of layers:
I. A first (Inner) layer is construed from a material that is inert to the compounds, to hold the oxide melt without thermomechanical failure or reacting with the materials or from the oxygen released during the reaction. The crucible (material which holds the oxide melt and contains the process) material could be BN, (High purity) alumina, (High purity) magnesia, Zirconia, a SiC—MgO—ZrO composite or any other Inert ceramic liner
II. A second layer, configured to be a magnetic susceptor for the process heat initiation. The layer could be constructed from a material, such as molybdenum, iron-Ni high heat resistant alloys or other ferro magnetic high melting point high heat resistant alloy.
III. A third layer, configured to maintain the reaction temperature. The third layer must be able to maintain its shape at the elevated reaction temperature and to reduce dissipation of the radiation heat. In some embodiments, the middle layer provides isolation. In some embodiments, the composition of the third layer is not characterized as ferromagnetic. In some embodiments, the third layer is formed as shaped as a coating (such as a reflective white coating) or as bricks (such as alumina bricks). The third layer could be constructed from BN, a High temp Cr alloy, Alumina, Magnesia or Ta.
IV. In some embodiments, the crucible comprises a fourth (outer) layer that forms an additional protective layer (an envelope), isolating the inner layer(s) from outer conditions and the environment. The outer layer could be constructed from a material that maintains it structure and provides insolation, such as quartz. In some embodiments, the outer layer is constricted from stainless steel comprising Al₂O₃ bricks.

In some embodiments the crucible (or reactor) is configured to control the environmental conditions. In some embodiments, the conditions refer to the gases contained in the reactor.

In some embodiments, the environment is a vacuum or comprises an inert gas (such as Argon Ar).

The crucible comprises:
I. Electrodes: creating constant or changing voltage, constant or changing current between two conducting elements with inverse electrical charge. The electrodes (i.e. anode and cathode) are placed apart (at least 1 mm) so as not to cause interferences, derived from the products which evolve on them but must be close enough for the process to be more efficient and to sustain appropriate electrochemical process, the transfer of electrons in one electrode and the receiving of electron on the other or to sustain joule-heating power. The potential would be E0=−1.42V (25 c). In some embodiments, there is a size ratio of at least 1:5 between the Anode and Cathode.
   Regarding the construction of Anode and Cathode:
      a. Anode: must be inert, as pertains to the electrolyte and the oxygen created in the reaction. The anode could be constructed from a material such as Iridium, Pt, PtRh or an alloy. In some embodiments, the structure of the anode enables O₂ evolution and efficient removal without being degraded itself.
      b. Cathode: must be inert and to not react or alloy with metallic liquid Si or electrolyte. The anode could be constructed from a material such as Iridium, Pt, PtRh or an alloy.
II. A heating unit, configured to reach an elevated temperature. The temperature could be up to 2000° C. In some embodiments the reactor heating unit is a Joule heating.
III. At least one temperature control unit, configured to detect the reaction/rector temperature. The unit could comprise a thermocouple. The unit could be positioned in various parts of the reactor unit: inside the crucible, on the outer crucible well, in the cool zone or on the outer furnace wall.
IV. A reference unit, constructed from a material such as iridium, Pt, PtRh or an alloy. In some embodiments, the reference unit is constructed from the same material as the Cathode.

2^{nd} section—cooling/solidification area, where the melted elemental Si (liquid) is cooled and to induce a crystallization. During coiling crystalline Si is deposited/adheres to a crystalline substrate seed. The seed could be characterized as a mono/single- or poly-silicon crystalline. In some embodiments, the seed is configured to position/reposition the seed and to remove the deposited crystal from the reactor.

The cooling section comprises a separate temperature control and temperature regulation (heating/cooling) system. In some embodiments, the heating system is characterized as induction heating.

Cooling area/section is constructed of a material stable at elevated temperature (<2000° c.) and does not react to the components of the mixture. In some embodiments, Silica should be used in the cooling area to prevent contaminations.

Shape: in some embodiments, the cell/cooling section? is shaped as a ‘funnel’, having a wide in the upper section and a narrower lower section.

The process of (polycrystalline)-silicon production:
1. Receiving sand (comprising SiO₂). In some embodiments, the sand is purified and filtered to remove contaminates (such as different metals, plastics etc.) and big chunks.
2. Mixing/Adding Oxide: The oxide characterized as:
   a. A Lewis base (donor);
   b. Stabile (Thermodynamic) at the reaction temperate (<2000° c.);
The oxide can be selected from a group of TiO₂, MgO, Li₂O, Al₂O₃ and CaO.

When mixed with the oxide, such as SiO₂, the oxide serves to form a eutectic system (forming a homogeneous mixture that melts at a temperature, lower than that of the SiO₂ or the Oxide), with both compounds melting at temperature lower than each compound separately. Each oxide would form a different system.

In some embodiments, the mixture forms a eutectic mixture, so that the melting point of the mixture is the lowest possible for the mixture.

The Oxide is characterized as:
i. lowering the melting temp, when mixed with silicon dioxide;
ii. act as an electrolyte, donating electrons to the SiO₂;
iii. forming a eutectic system with SiO₂;
iv. Other characteristics? Melting point? Boiling point?

The oxide could be TiO₂, MgO, Al₂O₃ or CaO or Li₂O.
3. Heating mixture to an elevated temperate, sufficient to melt the mixture of Si and metal oxide. The melting point of the mixture depends on:
   a. The compound (metal oxide) added to the SiO₂; and
   b. the ratio of two compounds.

A temperature of 1460-1500° C. would be used for a mixture of CaO with SiO₂ mixture at the eutectic point of 37% and 63% respectively. A temperature of 1550° C. is used for a mixture of TiO₂ and SiO₂, and a temperature of 1500° C. for a mixture of MgO and SiO₂.
4. Creating an electric potential to allow for the reduction of silicone dioxide to silicon, in the range of 1-3V.

The reaction can be described by the equation:

SiO2→electrical current through electrodes→Si+O2

In some embodiments, the reaction is continuously fed with raw materials, such as the oxide materials, to maintain pseudo-constant oxide ratio.
5. Cooling the mixture to room temperature (˜25° C.) from the reaction temperature, at the interface and continuing slowly toward room temperature as distance from total melt grows.

In some embodiments, the (cooled) temperature is a eutectic temperature, so that the conditions form a eutectic reaction, and that the contents simultaneous crystallize (separately). In some embodiments, the temperature is not a eutectic temperature and only the Si crystalizes at the reactor temperature.
6. Seeding/Contacting the cooled solution with a seed/Electrophoretic deposition (EPD): selective crystallization and deposition of the Si of the Si on the seed.
7. Extracting the solidified/crystallized (and cooled?) Si from the cell. In some embodiments, the extraction is conducted by removing the ‘seed’.

The applicant submits that the isolation and purification of the solidified/crystallized (slag removal and silicon separation) Si is well known in the industry common practice in the industry (Study on Physical and Chemical Properties of Industrial Silicon Slag, Qiao, D., et. al., 2021).

### Example

1. Mix Silicon dioxide and calcium oxide (37% CaO and 63% SiO₂) and place in cell/crucible.
2. Heat to a temperature 1450^{c}O in an inert environment (Ar)
3. generate an electric potential of 2-3V
4. cool to room temperature, at a rate of −2 degrees per minute.

Cell Construction:
a. Anode: Mo wire (00.8 mm)
b. Cathode: Ir wire (01 mm)
c. Reference electrode: Ir wire (01 mm)
d. Crucible: Bn
e. Environment: inert (Ar)

### Experiment

Reference is made to FIG. 3, showing the spectrogram (conducted on a x ray diffractometer), demonstrating the CV of CaO and SiO₂, specifically a peak at 1450° c., suggesting electrochemical behavior of oxides dissociation.

50 gr of 37% w/w CaO and 63% w/w SiO₂ was placed in an aluminum oxide cell. The cell was heated to a temperature was 1450° c. and the chronopotentiometric was conducted for 2 h.

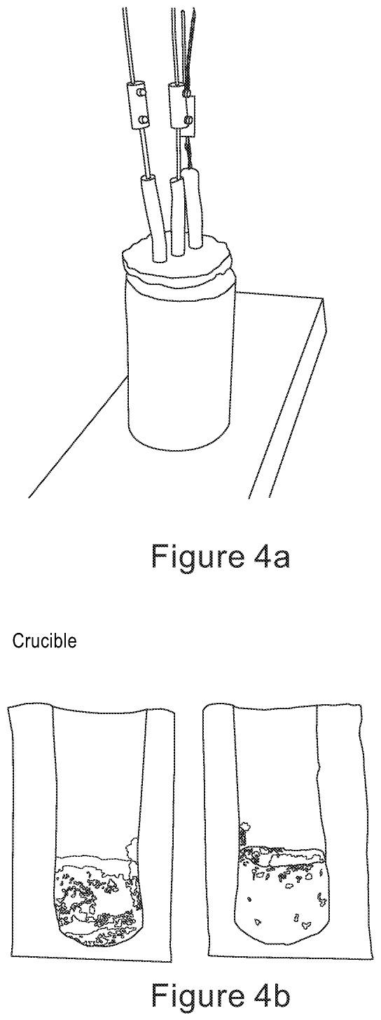

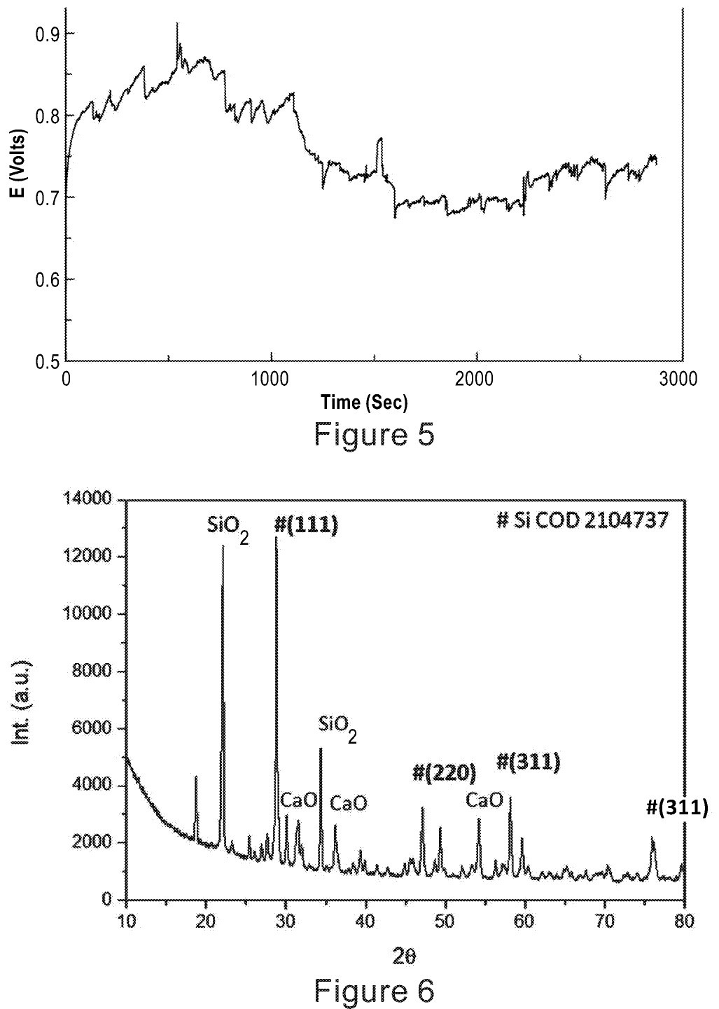

The slag at the bottom of the reaction crucible (FIG. 4 a-b) is a uniform material, with a different color from starting material. The Voltage variation during chronopotentiometry test of SiO₂—CaO melt at 1450 and 100 mA for 50 min (FIG. 5) The test was conducted using an 1700 c rating muffle furnace by Across international, the potentiostat used was by Solarton SI 1287. 3 electrodes were inserted into the BN crucible. The electrode was constructed from Mo.

FIG. 6 shows the analysis of the silicon product using a Bruker X ray diffractometer (XRD). Native silicon is clearly visible in large peaks (111) (220) (311) (331). Peaks corresponding to SiO₂ can be seen at 22 and 34. The presence of silicon Oxide in the product sample demonstrates that dissociation of SiO₂ through an electrochemical reaction. This demonstrates the presence of face centered cubic (FCC) silicon structure.

1. A method of producing crystalline Silicon, comprising steps of:
a. Mixing silicon dioxide and at least one metal oxide;
b. Heating/melting said silicon dioxide and metal oxide mixture;
c. creating an electronic potential;
d. cooling said Si;

2. The method of claim 1, wherein said oxide is characterized by at least one of the following:
a. Being a Lewis base (donor);
b. Stabile (Thermodynamic) at a temperature of >2000° c.;
c. does not react with SiO₂ or Si.

3. The method of claim 1, wherein said oxide is selected from a group consisting of TiO₂, MgO, Li₂O, Al₂O₃ and CaO.

4. The method of claim 1, wherein said oxide is present at a ratio by weight of 1:1 to 1:3 by weight to said Silicon dioxide.

5. The method of claim 1, wherein said metal oxide and silicon oxide mixture is characterized as forming a eutectic system.

6. The method of claim 1, additionally comprising a step of providing a crystalline seed.

7. The method of claim 6, wherein said seed is characterized as poly- or mono-crystalline.

8. The method of claim 1, wherein said heating is characterized as a melting temperate of said mixture.

9. The method of claim 1, wherein said product is characterized as poly- or mono-crystalline.

10. The method of claim 1, wherein only said cooling is characterized as only crystalizing said silicon.

11. A method of producing silicon, characterized by mixing silicon dioxide and at least one metal oxide at an elevated temperate wherein said oxide and silicon form a eutectic mixture or eutectic system.

12. The method of claim 11, wherein said oxide is characterized by at least one of the following:
d. Being a Lewis base (donor);
e. Stabile (Thermodynamic) at a temperature of >2000° c.;
f. does not react with SiO₂ or Si.

13. The method of claim 11, wherein said oxide is selected from a group consisting of TiO₂, MgO, Li₂O, Al₂O₃ and CaO.

14. The method of claim 11, wherein said oxide is present at a ratio of 1:1 to 1:3 by weight to said Silicon dioxide.
